(19) United States
(12) Patent Application Publication
(10) Pub. No.: US 2024/0370654 A1
(43) Pub. Date: Nov. 7, 2024

(54) REINFORCED DATA TRAINING FOR GENERATIVE ARTIFICIAL INTELLIGENCE MODELS

(71) Applicant: OBRIZUM GROUP LTD., Cambridge (GB)

(72) Inventors: Christopher PEDDER, Cambridge (GB); Chibeza Chintu AGLEY, Cambridge (GB)

(73) Assignee: OBRIZUM GROUP LTD., Cambridge (GB)

(21) Appl. No.: 18/652,152

(22) Filed: May 1, 2024

Related U.S. Application Data
(60) Provisional application No. 63/499,420, filed on May 1, 2023.
(60) Provisional application No. 63/501,930, filed on May 12, 2023.

(51) Int. Cl. G06F 40/30

(52) U.S. Cl. CPC G06F 40/30

(57) ABSTRACT

Disclosed reinforcement learning from human feedback techniques provide reward and loss functions for human raters to improve the quality of the feedback data. A certain number of credits are provided to a human rater. The human rater allocates credits to output options that reflect a response or responses to a prompt. The allocations of the credits represent a confidence-weight label for the output options and collectively represent user feedback on the output options. The human rater is rewarded points when the user feedback decreases uncertainty of an AI model. Conversely, the human rater can lose points when the user feedback does not decrease uncertainty of the AI model. A reward model is generated and/or trained based on the user feedback. The AI model is trained based on the reward model.

### CROSS-REFERENCE TO RELATED APPLICATION(S)

This application claims priority to U.S. Provisional Application No. 63/499,420 titled “REINFORCED DATA TRAINING FOR GENERATIVE ARTIFICIAL INTELLIGENCE MODELS” filed May 1, 2023, and to U.S. Provisional Application No. 63/501,930 titled “REINFORCED DATA TRAINING FOR GENERATIVE ARTIFICIAL INTELLIGENCE MODELS” filed May 12, 2023, which are incorporated by reference for all purposes herein.

### TECHNICAL FIELD

The present disclosure relates generally to content management systems and examples of emphasizing subjects or content items within content management systems.

### BACKGROUND

Reinforcement learning from human feedback (RLHF) currently works by asking human labelers to select the single best completion to a given document, or the single best response to a model prompt to produce a product, such as artwork or freeform text. Artificial intelligence (AI) models contain an inbuilt measure of the utility of a given completion (an exact calculation or estimate of the loss function for a given response), but they often require a second layer of human feedback for fine tuning to achieve sufficient quality in their responses.

One solution is to use active learning, where human labelers are present with only the examples that the AI model itself had the most difficulty with (these are usually cases where the AI model finds that two or more responses are close in their scores). Using the most difficult examples for the machine to differentiate between as the next set of testing examples for the machine learning algorithm reduces the number of examples the AI model has to see in order to perform better. However, this approach fails to elicit more of the available information from a single annotation. Attempts to get human labelers to provide a scalar “score” feedback on multiple examples without an individual reward system (which provides corrective positive and negative feedback to human labelers) have tended to produce noisy and uncalibrated results. This has resulted in simple binary rankings systems predominating with consequent loss of available information.

### SUMMARY

In one aspect, an example method for training an artificial intelligence (AI) model described herein includes providing, to a user device, a user interface displaying at least a prompt, a plurality of output options to the prompt and an amount of credits to be apportioned to the plurality of responses and receiving, from the user device via the user interface, confidence-weighted labels for one or more of the plurality of output options to the prompt. Each confidence-weighted label comprises a respective allocation of credits. The method further includes based on a determination that the confidence-weighted labels reduce uncertainty of an artificial intelligence (AI) model, generating and training a reward model using the prompt and the confidence-weighted labels. The reward model is trained using one or more training datasets that are weighted by confidence-weighted labels. For example, the one or more training datasets can include some or all of the confidence-weighted labels received from the user device and/or from one or more groups of human raters. The AI model is trained based on or using the reward model.

In another aspect, an example method of reinforcement learning from human feedback includes receiving, from one or more artificial intelligence (AI) models, a plurality of output options and providing, to a user device, a user interface displaying at least the plurality of output options associated with a prompt and an amount of credits to be apportioned to the plurality of output options. An allocation of credits to each output option in the plurality of output options is received. Each allocation of credits ranges between a first amount of credits and a second amount of credits, and the allocations of credits comprise user feedback on the plurality of output options. Based on the user feedback, reinforcement learning from human feedback training is performed to train at least one of the one or more AI models. The reinforcement learning from human feedback training can include generating and/or training a reward model, where the reward model includes and/or is trained using one or more training datasets that are weighted by confidence-weighted labels.

In yet another aspect, a system includes a processor and a memory. The memory stores instructions, that when executed by the processor, cause operations to be performed. The operations include receiving, from an artificial intelligence (AI) model, a plurality of output options, where the plurality of output options are based on a prompt. An allocation of credits to each output option in the plurality of output options is received from the user device via the user interface. Each allocation of credits ranges between a first amount of credits and a second amount of credits, and the allocations of credits comprise user feedback on the plurality of output options. Based on a determination that the user feedback reduces an uncertainty of the AI model, a reward model is generated and/or trained based on the user feedback, and the AI model is trained based on the reward model.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

FIG. 1 illustrates a block diagram of an example computer system according to an embodiment of the disclosure;

FIG. 2 illustrates a display diagram illustrating elements of a graphical user interface that can be displayed on a display according to an embodiment of the disclosure;

FIG. 3 illustrates a display diagram illustrating a first graphical user interface and a second graphical user interface that can be displayed on a display according to an embodiment of the disclosure;

FIG. 4 illustrates a block diagram of a workflow according to an embodiment of the disclosure;

FIG. 5 illustrates a flowchart of an example method of training an artificial intelligence model according to an embodiment of the disclosure; and

FIG. 6 illustrates a flowchart of a method for training an artificial intelligence model in accordance with an embodiment of the disclosure.

The description will be more fully understood with reference to the following figures in which components are not drawn to scale, which are presented as various examples of the present disclosure and should not be construed as a complete recitation of the scope of the disclosure, characterized in that:

### DETAILED DESCRIPTION

Reinforcement learning from human feedback is a means of applying additional policy on top of the intrinsic loss function used when training a machine learning model from a curated dataset without human feedback. Recent developments have moved beyond the use of reinforcement learning to use direct policy optimization and Bradley-Terry preference models (DPO) to directly change the behavior of a neural network, without needing to train a separate network to ensure appropriate performance. By receiving human feedback, the policy network can apply corrections to the results from the intrinsic loss function of the predictor network; this allows networks like ChatGPT or other Generative AI models to be trained not to produce harmful content when asked harmful, destructive, or improper prompts, such as “how to make a bomb”, despite this information being available in the training set and likely to be produced by the base network in response to such prompts or questions.

Collection of human feedback is costly and time consuming, and can suffer from problems of human labelers (e.g., reviewers, raters, or users) misunderstanding the problems, misalignment of human objectives to those of the project, malicious or unhelpful actors providing less useful or harmful information, or even contextual misalignment or ambiguity in the task. In particular, the way in which most of these human labelers are carried out requires the human labelers to choose between several options for the correct completion of a piece of text (e.g., a prompt or question). The feedback is used to refine the policy network, making it more likely that the “correct” or the better answer provided by the human labelers will be returned by the AI model the next time the same prompt is given. The term AI model is intended to cover machine learning models, probability models, generative AI models, large language models (LLMs), and the like.

Providing feedback for a system's current behavior using human feedback, also known as “Reinforcement Learning From Human Feedback” (RLHF) is an increasingly popular means of creating a reward structure to help shape desired behaviours for the AI models to learn. However, this approach is expensive in terms of both financial costs and time-often requiring hundreds or even thousands of person hours. Additionally, RLHF relies heavily upon humans being able to accurately evaluate the outputs of the AI models and often does not incentivize attention, honesty, and/or accuracy for the human operators. Humans make mistakes in evaluation and can be prone to boredom in repetitive tasks, such as the review required for such RLFH.

Accordingly, there is a need for technologies that improve quality of human feedback data and efficiency of its collection, which would in turn to enable a reduction in the total amount of feedback required.

The disclosed technology improves over existing RLHF techniques by providing reward and loss functions for the human testers via a computer system and software to improve the quality of the feedback data. According to the disclosed technology, a human labeler allocates credits to output options they believe most accurately reflects the desired behaviors. They are rewarded points when their votes or selections decrease the uncertainty of the AI model and lead to the desired behaviors. The amount of points that is awarded can be based on the impact that the human labeler (e.g., through their selections) has on improvements to an AI model. For example, the human labelers receive greater rewards for being more accurate. The term “credits” is intended to cover any type of unit that can be allocated, such as credits, icons, money or other incentives. The term “points” is intended to cover any type of reward, including, but not limited to, points, icons, badges, credits, money or the like.

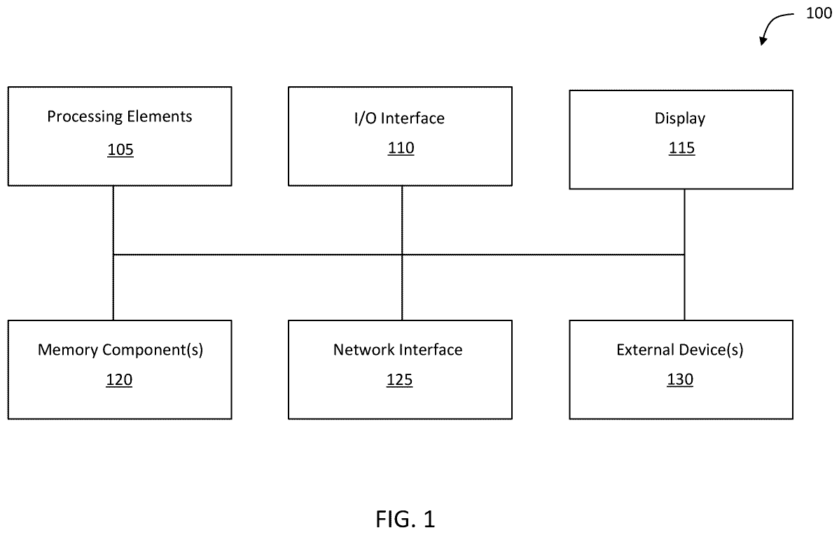

The points may be stored in a system memory (e.g., one or more memory components 120 in FIG. 1), such as being associated with a user profile associated with the human labeler, settings, or the like. Conversely, points are subtracted from the review's profile when their input was inaccurate, unhelpful, or otherwise undesirable, e.g., “poisonous”. In this way the human labelers also learn to prioritize accurate and truthful preferences, which help optimize better rewards functions-thus reducing the amount of content required to train the AI models. As well as being ranked as a result of this credit-based human feedback, output options also have additional uncertainty attached to them—these additional weights or characteristics can be used to improve the diagnostic understanding of reward functions, and the training process for reinforcement learning systems more generally.

The fact that existing systems only allow human labelers to provide one answer limits the capabilities of such systems because these systems fail to collect additional information available from human labelers, and as a consequence fail to store and include additional data that would be useful for more accurate training. Eliciting confidence-weighted labels or other input characteristics provided by the human labeler or review helps to simultaneously reduce the time requirements for human labelers, system training time and computational power, and the amount of energy for retraining the policy network. In addition, labelers are often paid or compensated “per example,” e.g., on a production type of system, and in such situations, are under significant time pressure to produce or review tasks more quickly. Even if this is not the case, the human labelers may work for extended periods during which their attention will fade, energy wan, or the like. As such, the quality of the feedback may suffer, but in ways which are hard for data scientists to measure or notice.

In some implementations, the disclosed technology provides human labelers a certain number of credits (e.g. 100, 200, or other amount) to apportion between various possible outcomes (e.g., a process referred to as “confidence-weighted labeling”). In these and other implementations, the disclosed technology allows human labelers to use confidence sliders or other user interface (UI) input features to indicate the level of confidence in results. The disclosed systems are designed to engage users more, and encourage them not only to click on a given box, but instead to consider their own uncertainty and also potential ambiguity in the problems they are seeking to annotate. Giving a high confidence to a particular option reflects relative certainty in one's answer, whereas spreading confidence equally between several outcomes can show that there may be several accurate completions, or that the human rater is operating outside of their comfort zone. It should be noted that in many implementations, the UI input features may be selectable or modifiable by the labeler via an input device, such as a sliding scale where an icon is moved along a bar between lower and higher confidence end points, a numerical input corresponding to a confidence selection, an icon selection from a menu of options corresponding to different confidence values, or the like. In many embodiments, the configuration of the UI input features may be selected to be engaging and fun with the labeler and may change across time or different prompts to help maintain or increase engagement over a period of time.

Whilst asking human raters to consider N possible options clearly increases their time to answer (e.g., we can assume that it will roughly be N times the amount of time to choose between two options), we are acquiring of the order of N² comparisons from the human labeler by asking the labeler to annotate this way. Whilst very large values of N will clearly suffer from the limits of human attention and memory, at more moderate values we are effectively reducing the amount of time it takes to acquire a particular amount of information from human raters by N. In other words, although the additional input of a confidence metric will take additional time and possibly reduce the number of prompts reviewed by the human labelers, the additional confidence metric or confidence input received by the system will increase the value of the dataset and help to increase the training accuracy of the models.

It is now becoming known that large language models (e.g., LLMs or AI models) can be severely negatively impacted (e.g., poisoned) or otherwise skewed via crowd-sourced or other human instruction tuning attacks in which coordinated groups of bad actors label textual responses in a suitable, fine-tuned way, but with inaccurate, harmful, otherwise undesirable information. This has the effect of confusing the AI model, and can be carried out because of the digital nature of the feedback from the human raters. Using a confidence-weighted approach, as described herein, such attacks would be harder to carry out, as low levels of certainty from human raters would have little impact, and a correlation of high levels of certainty and the subject-specificity required for a successful attack would be easy to spot statistically, allowing such information to be disregarded. The disclosed technology therefore allows easier filtration of bad actors or other undesirable inputs through simple statistical analysis of their responses, and of poor or unreliable human labelers by penalising their scores.

Another issue that can arise in human rater environments stems from time pressure, e.g., from human raters trying to produce as many reviews as possible within a given time period that can cause some of the annotations to be rushed or not as well thought through. In some implementations, the disclosed technology can combine confidence-weighted labeling with a rewards system, which can allow truth-telling a Nash equilibrium property of rational agents in the space. Examples of means to score the contributions of the human labellers can include one or more options. For example:
(a) Rewarding the human raters by an amount of credits they allocate to the correct answer according to the rest of the human labelers, minus the amount of credits that the human raters allocate to incorrect answers;
(b) Computing the discrete Kullback-Leibler divergence or other statistical distance determinations between the human rater's implied expectation of which responses are correct and the group's calculated distribution of expectations;
(c) Using an approach like the Peer Truth Serum (PTS) or other logarithmic, but treating the reward function in that case as a “points” contribution, which has mean zero (e.g., contributions are all reduced by the mean value of the reward available to a human rater at each step); and/or
(d) Rewarding the human labelers based on the amount of loss function their individual contribution managed to save in the RLHF system's loss function (e.g. an approach including or similar to approaches such as Training Data Attribution scoring, described in a paper entitled “Simfluence: Modeling the Influence of Individual Training Examples by Simulating Training Runs”), such that surprising but useful contributions would be best-rewarded. As described in the paper, training data attribution methods offer to trace a model's prediction on any given example back to specific influential training examples. A copy of the paper can be found at the Cornell University website (https://arxiv.org/abs/2303.08114).

One application of the PTS approach (e.g., as described in paragraph (c) above) would reward users based on the relation of their distribution of confidence to that obtained from the rest of the cohort, which is normally not possible because existing systems lack access to the full prior expectations of the human rater. As a consequence of any of these rewards systems, users who tell the truth would amass the most points, whereas the users that provide misleading or static answers would receive negative points contributions.

In some examples, the system described herein utilizes confidence-weighted labeling, in concert with a points-based reward system to engage the metacognition of human raters and make the raters aware of their intrinsic uncertainty in the problem. This will enable those using the data to use this uncertainty as an additional piece of feedback to improve the performance of RLHF systems with less data.

Use of a novel points-related payments approach will help ensure that human raters are well-incentivized, and the confidence weighting can be used as a proxy for their prior expectations, which is usually unavailable in systems where the peer truth serum can be used. This would allow for faster convergence of results, and a consequent cost saving for organizations training RLHF AI models. Such are the potential efficiency gains from the improvements in data quality afforded by the disclosed technology, that the number of physical servers or computers needed to train the AI models, and the associated real-estate and energy requirements to run/maintain the servers, would be dramatically reduced with the resultant impact on the environment minimized.

Some or all of the confidence-weighted labels are included and/or used to train a reward model for one or more AI models. For example, the confidence-weighted labels that reduce uncertainty in the AI model(s) may be included in one or more training datasets. In this manner, the one or more training datasets are weighted by the user feedback (e.g., the confidence-weighted labels), and the confidence-weighted training dataset(s) are part of (e.g., used to trained) the reward model. The confidence-weighted labels are fed into the reward model to generate the reward function. Essentially, the disclosed embodiments provide reward and loss functions for the human labelers to improve the quality of the user feedback, and the improved user feedback is used to improve the quality of the reward model that is used to train the AI model(s). The disclosed embodiments provide reinforcement learning in both situations; to the reward model and to the human labelers. With respect to RLHF, the human labelers provide the human feedback aspect of RLHF and the reward model provides the reinforcement learning aspect of RLHF.

Approaches and systems described herein may allow for presenting more than two options using a points-based metacognitive approach. Because a more efficient means of annotation is used, the approach utilizes fewer human operators, can produce larger volumes of better quality data, and human raters may be exposed to fewer examples of toxic content due to annotations putting guardrails around text or image generation. With recent developments in DPO, this may be done in minibatches when small amounts of data have been collected, such that harm is minimized even more effectively.

Confidence-weighted labeling may further allow AI model builders to gauge a level of uncertainty for annotations, which is useful when natural language is ambiguous. Group-level norms may further be used to assess the quality of the human labelers and to improve the contributions of the human labelers by encouraging the labelers to score more points. Scores may further be aggregated at a group level as added motivation, providing instant feedback for labelers on efficiency. In some examples, the footprint of the method may be compared to an amount of carbon produced by a traditional binary method, which may be translated into points. In some examples, individual scores could allow effective workers to work less, utilizing adaptive schedules executed automatically via the software. The methods and systems may further offer a means of improving “secondary options” using knowledge of the distribution.

In some implementations, the disclosed technology provides one or more graphical user interfaces (GUIs) for instrumental learning to improve RHLF. Via the one or more GUIs, the human rater is given a visualization of two or more output options, which can be short movie clips, images, natural language, or other output options of an AI model. The human rater then indicates which output options the human rater prefers and gives a confidence rating for the rater's answer, and the human rater can deploy credits relative to their confidence/preference via the one or more GUIs. The human raters are either awarded points (i) based on the responses of a group of human raters as a whole and/or (ii) on the extent to which the uncertainty of the AI model is reduced. If the human raters do not like any of the output options, or they are unable to compare the output options, the human raters can choose to allocate all of the credits to a ‘None’ option; in this case the comparison is not included in the database.

The human judgments submitted via the GUI are recorded in a database containing the two or more output options and a distribution over these indicating the relative preference for the outputs. If the human labeler selects one output option as 100% preferable, then the full weight of the distribution is awarded to that output option. If two output options are identically preferred the distribution will be flat.

Human raters lose points if their preferences are inaccurate or unhelpful. The system will record the time-to-answer for each assessment, but this may not be visible to the human raters. As participants can voluntarily trade speed for accuracy, response time (RT) and accuracy are not independent variables, so having both variables can be useful to support diagnostics on human decision making—and are a proxy for perceived difficulty. The speed of the movement of an input device (e.g., a mouse or stylus) can also be recorded to assist with user profiling and in confirming that a human being is submitting the results.

The points system can provide a game-like type of environment for the human labelers. In some implementations, multiple human labelers may compete against one another to see which human labeler can score the highest number of points (or other reward). To ensure the human labelers consider each output option and provide thought-out confidence-weighted labels, the labeling sessions can execute for a fixed amount of time to reduce a sense of urgency a user may experience in a gaming environment. In one embodiment, the system can display the top performers or the earned points to encourage more accurate inputs and/or additional labeling sessions.

The disclosed technology addresses problems related to constructing reward functions for highly complex tasks for use in reinforcement learning. Simply designing a reward function based on an approximation of the intended behaviors can lead to a result which optimizes the reward function, but fails to really align with “how” an Al model should be trained (Christiano et al. 2017; Bostrom, 2014; Russell, 2016; Amodei et al., 2016). These challenges highlight the potential for misalignment between human preferences and the objectives of reinforcement learning systems. The disclosed technology addresses these problems using the disclosed techniques for rewarding accurate and/or helpful behaviors and/or penalising inaccurate and/or unhelpful behavior.

Advantages of the disclosed technology include reducing the cost of human oversight to enable the technology to be applied at a greater scale to improve state-of-the-art AI models. Additionally, because the disclosed technology includes uncertainty metrics for each bit of data as it enters the AI model, the amount of data required to improve the predictive accuracy can be dynamically improved (e.g., optimized). The disclosed technology also provides diagnostic pinpointing as to where in the training dataset the greatest challenges lie. The disclosed techniques reduce the opportunity for data poisoning.

Further, the disclosed technology can better discover cultural/group preferences, human biases, or irrationality. Machine learning can be applied to data collected using the disclosed technology to determine the accuracy and the reliability of the human raters. The disclosed techniques can improve the motivation and attention of the human labelers when performing many tasks, as humans are prone to boredom. Furthermore, the disclosed techniques can be used to improve the safety and performance of AI models (e.g., LLMs) as the AI models continue to scale, such as by helping to ensure that the AI models are aligned with human preferences.

According to the disclosed techniques, human labelers who are found to have predictable distributions or otherwise provide low-quality data can be prevented from continuing.

Additionally, the disclosed technology provides an unbiased way of rewarding contributors of RLHF tasks based on their effectiveness at the task. The disclosed technology can be used with machine learning analysis to learn the perceived difficulty of certain sets of information, where this information is not easily extracted from existing RLHF approaches. Furthermore, the disclosed technology will optimize the number of output options (e.g., images/videos/text) that humans need to rate-thus enabling more efficient and cost-effective time allocation. This system may also be connected to an adaptive scheduling system.

The disclosed embodiments can also influence and improve the accuracy of the rank ordering (e.g., ranking) of the results (e.g., the confidence-weighted labels) from the human labelers that are used to train the reward model. The improved ranking enables the stable human preferred rank to be determined more quickly and with less data. For example, the additional probabilities help determine the correct order of preference.

The systems and methods described herein may be implemented using a computer system, such as the example computer system 100 shown in FIG. 1. A computer system 100 may be used to implement or may be integrated into one or more components of systems described herein. In FIG. 1, the computer system 100 may include one or more processing elements 105, an input/output (I/O) interface 110, a display 115, one or more memory components 120, a network interface 125, and one or more external devices 130. Each of the various components may be in communication with one another through one or more buses, communication networks, such as wired or wireless networks.

The processing element(s) 105 may be any type of electronic device capable of processing, receiving, and/or transmitting instructions. For example, the one or more processing elements 105 may be a central processing unit, microprocessor, processor, or microcontroller. Additionally, it should be noted that some components of the computer system 100 may be controlled by a first processor and other components may be controlled by a second processor, where the first and the second processors may or may not be in communication with each other.

The memory component(s) 120 are used by the computer system 100 to store instructions for the processing element(s) 105, as well as store data. The one or more memory components 120 may be, for example, magneto-optical storage, read-only memory, random access memory, erasable programmable memory, flash memory, or a combination of one or more types of memory components.

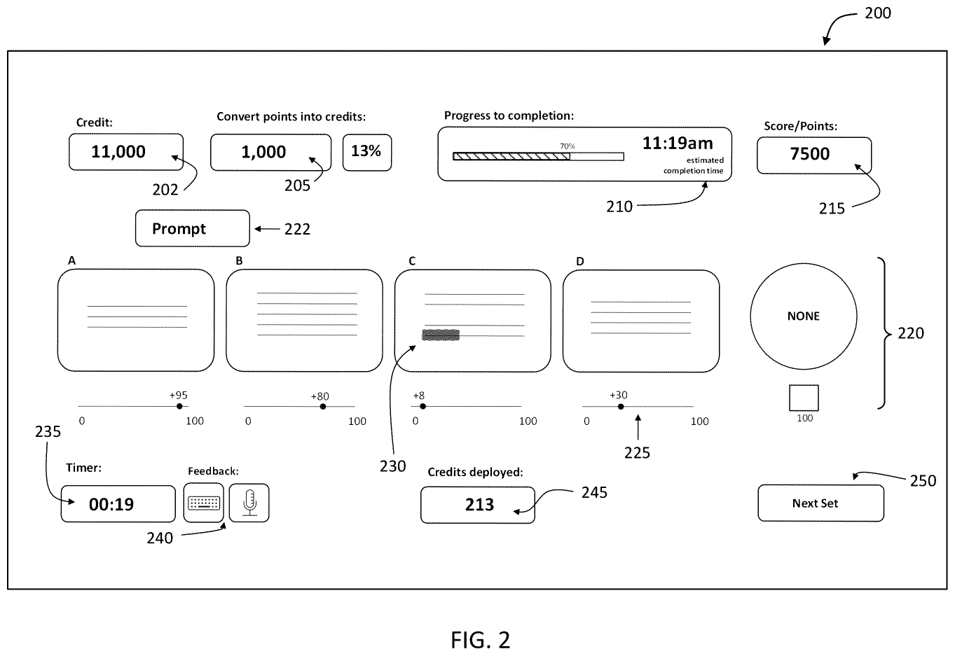

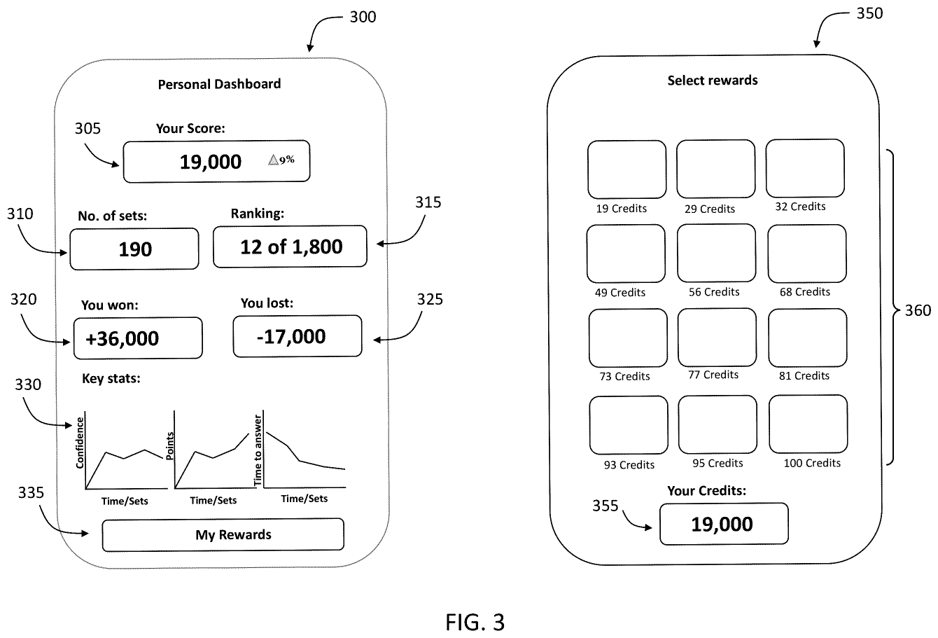

The display 115 provides visual feedback to a user. Optionally, the display 115 may act as an input element to enable a user to control, manipulate, and calibrate various components of systems described in the present disclosure. The display 115 may be a liquid crystal display, plasma display, organic light-emitting diode display, and/or other suitable display. In embodiments where the display 115 is used as an input, the display may include one or more touch or input sensors, such as capacitive touch sensors, a resistive grid, or the like. The display 115 may be configured to display one or more graphical user interfaces, such as the graphical user interface of FIG. 2 and/or the graphical user interface of FIG. 3. In some implementations, the one or more processing elements 105 may be configured to transmit one or more graphical user interfaces, such as the graphical user interface of FIG. 2 and/or the graphical user interface of FIG. 3, to the display 115 for presentation.

The I/O interface 110 allows a user to enter data into the computer system 100, as well as provides an input/output for the computer system 100 to communicate with other devices or services. The I/O interface 110 can include one or more input buttons, touch pads, and so on.

The network interface 125 provides communication to and from the computer system 100 to other devices. The network interface 125 includes one or more communication protocols, such as, but not limited to Wi-Fi, ETHERNET®, BLUETOOTH®, and so on. The network interface 125 may also include one or more hardwired components, such as a Universal Serial Bus (USB) cable, or the like. The configuration of the network interface 125 depends on the types of communication desired and may be modified to communicate via Wi-Fi, BLUETOOTH®, and so on.

The one or more external devices 130 are one or more devices that can be used to provide various inputs to the computer system 100, e.g., mouse, microphone, keyboard, trackpad, or the like. The one or more external devices 130 are also one or more devices that may be used to provide various outputs from the computer system 100 (e.g., printer, storage device, other computer system). The external device(s) 130 may be local or remote and may vary as desired. In some examples, the one or more external devices 130 may also include one or more additional sensors.

FIG. 2 illustrates a display diagram illustrating elements of a graphical user interface that can be displayed on a display according to an embodiment of the disclosure. The depicted elements can be provided by a system via one or more graphical user interfaces (e.g., graphical user interface 200) via which human labelers interact with the system to provide feedback for training an AI model, according to implementations described herein. The system can be a computer system that includes some or all of the components shown in FIG. 1.

A credit indicator 202 indicates an amount of credits available to a human labeler of the system. As described herein, the system can provide a maximum amount of credits that must be ‘spent’ across all response sets. The credits can also define or correlate to how many sets each human rater will/should see in a session. As described herein, the credits can be allocated to particular outputs of an AI model to indicate a correct response, a best response, or the like.

A conversion component 205 can allow a user to convert earned points into credits to be used. In other words, points earned by a user of the system can be converted to credits, and users can choose to invest those converted credits to deploy against output options (e.g., to earn more credits). These credits can come from a fixed bank or can be converted from points in any ratio of points to credits. The conversion component 205 can depict the amount of credits, for example, as a numerical value and/or as a proportion of a total number of credits or points (e.g., a percentage of credits).

A time to completion indicator 210 indicates an estimated time to complete all responses. The estimated time to completion can be dynamically calculated based on, for example, time-to-answer (response time) for one or more sets of outputs, confidence, veracity, credit, and so forth. Additionally or alternatively, the time to completion indicator 210 can include a progress indicator, such as a progress bar that indicates a percentage of response sets completed.

A points indicator 215 indicates a score and/or number of points earned by the human labeler. Points can be determined adaptively based on model uncertainty. A score can be a result of any points won and/or lost as a result of the dynamic scoring system. In some implementations, points are awarded and/or subtracted as a function of confidence and veracity—with veracity being defined based on consensus or relative consistency across a group of users. As described earlier, points can be reflected in any units, including units of currency. As described herein, points can be awarded for responses that are generally more correct, accurate, or helpful, and points can be reduced for responses that are generally more incorrect, inaccurate, or unhelpful.

Graphical user interface elements presented by the system can include a prompt 222 and a set of output options 220 upon which a user's responses are based. The set of output options 220 are potential responses to the prompt 222. In some implementations, a ‘pass’ or ‘none’ option can be provided in case all the output options 220 are incorrect. In these and other implementations, a binary switch or tick box may also be used in the place of a confidence metric and/or in addition to a confidence metric.

The output options 220 can include, for example, language outputs, such as blocks of text from which the user selects an option that the user believes to be correct, believes to be the best answer, or the like, with respect to the prompt 222. Additionally or alternatively, the user can rate the options based on the prompt 222, such as by indicating a best answer followed by a next best answer, and so on. In the depicted example, the output options 220 include option A, option B, option C, option D, and a “None” option, although any number of output options can be used, and a “None” option may be omitted in some implementations. In some implementations, the output options 220 can be generated by two or more AI models simultaneously. The user rates each of the output options 220 using the user's credits. For example, the system can provide a slider 225 that can be manipulated by one or more user inputs (e.g., by clicking and dragging) to allocate credits to each of the output options 220. In the illustrated embodiment, sliding the slider 225 to the left decreases an amount of credits allocated and sliding the slider 225 to the right increases the amount of credits allocated. The amount of credits allocated to an output option can indicate a confidence score or measurement, such as an indication of the user's confidence that the corresponding output is correct or is the best or most likely output. In some implementations, the system can set a minimum and/or maximum amount of credits that must be ‘spent’ fully on a response set. This number can be dynamically adjusted based on AI model uncertainty.

In some implementations, the system can provide an ablation indicator 230. For example, for natural language responses where the user selects an answer, but the user has relative low confidence in the answer (e.g., less than 50%, less than 25%, less than 10%), the user can use the ablation indicator 230 to indicate a portion of an output option 220 for ablation, such as by highlighting a portion of the response that is unclear, incorrect, or the like.

A response timer 235 can be provided to count up or count down while a human labeler is responding to a set of output options 220. A time to answer indicated via the response timer 235 can be fixed and/or or can be dynamically adjusted based on one or more user characteristics, characteristics of a group of responders, and/or based on AI model uncertainty.

A feedback component 240 can be provided to allow the user to provide feedback about one or more output options 220. For example, additional commentary or feedback from human raters can be given in text or audio form, such as by clicking or otherwise selecting the feedback component 240.

A credits deployed indicator 245 indicated a total number of credits deployed by the human labeler, such as a number of credits allocated across all output options 220 in a given set, or across multiple sets.

A next button 250 can be provided to allow a user to complete a current set of output options 220 and move on to a next set of output options 220, such as by clicking. In some implementations, the next button 250 is not ‘clickable’ until a correct number of credits (if applicable) has been deployed, such as in implementations where a minimum number of credits must be allocated in each set of output options 220.

FIG. 3 illustrates a display diagram illustrating a first graphical user interface and a second graphical user interface that can be displayed on a display according to an embodiment of the disclosure. The first graphical user interface 300 provides a personal dashboard with performance information related to a human labeler's interactions with the system. The personal dashboard can provide various information regarding the user's performance when interacting with the system. For example, a score indicator 305 indicates a total or net score (e.g., number of points) earned by a human labeler. A count indicator 310 can indicate a number of sets of output options reviewed by the user. A ranking indicator 315 can indicate a total ranking for the human labeler out of a number of human labelers (e.g., based on total points won, sets reviewed, or other performance indicators or combinations thereof). A points won indicator 320 can indicate a total number of points won by the user, such as by providing correct, accurate, and/or helpful responses. A points lost indicator 325 can indicate a total number of points lost by the user, such as by providing incorrect, inaccurate, and/or unhelpful responses. A key stats region 330 can provide various statistical information or analyses, such as graphs, charts, plots, and so forth, to indicate the user's performance. For example, the system can provide statistical information or analyses indicating speed, accuracy, confidence, points earned/lost, or the like, and/or analysis indicating the user's performance over time, on an absolute basis, on a relative basis (e.g., compared to other users), and so forth. A rewards button 335 can be provided that, when selected, allows the user to view options for redeeming the user's points for rewards. For example, selecting the rewards button 335 can cause display of the second graphical user interface 350, which provides a rewards page.

The rewards page provided by the second graphical user interface 350 includes a credit indicator 355 that indicates an amount of available credits earned by the user through interactions with the system. Additionally, the rewards page includes a set of reward options 360, each including a number of credits needed to redeem a respective reward. The rewards can be any kind of reward, such as goods, services, money, gift cards, virtual items, or anything of value. When a user selects one of the reward options 360, the user can receive the indicated reward in exchange for a corresponding number of credits.

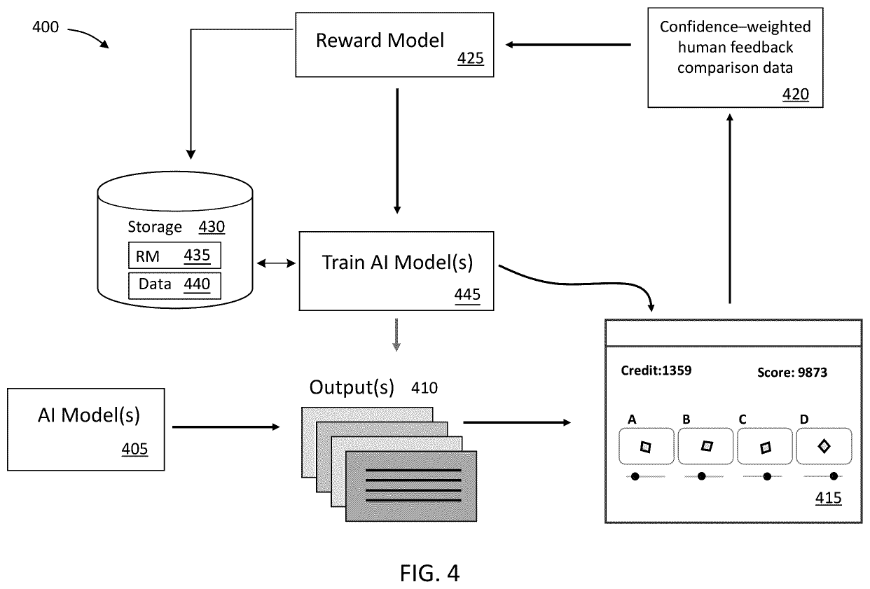

FIG. 4 illustrates a block diagram of a workflow according to an embodiment of the disclosure. The workflow 400 uses one or more AI models 405 to generate outputs 410. The one or more AI models may be pre-trained AI models. In one embodiment, the outputs 410 are generated by one or more LLMs based on a prompt. A user interface 415 is provided to a user device, where the user interface displays the prompt and the outputs 410 as output options for which a user provides feedback. For example, the prompt and the outputs 410 can be provided as the prompt 222 and the output options 220, respectively, shown in FIG. 2. Accordingly, the outputs 410 and the prompt are provided to the human labeler via the user interface 415, so that the human labeler can provide feedback on the outputs 410 with respect to the prompt, such as by allocating credits to the outputs 410, providing annotations for the outputs 410, providing typed or audio feedback, and so forth.

The workflow 400 further includes comparing feedback received via the user interface 415 against confidence-weighted human feedback comparison data at block 420. For example, feedback provided by the human labeler can be compared to feedback provided by a group of users, and an amount of points can be awarded to the user based on the comparison.

At block 425, a reward model can be generated and/or trained at block 420. In one embodiment, the reward model may be an AI model. The reward model may include or be trained with one or more training datasets that are weighted by the user feedback (e.g., the feedback from the one user and/or from confidence-weighted user feedback comparison data (e.g., the user feedback of a group of human raters as a whole)). The one or more training datasets are weighted by user feedback that is helpful, accurate, correct, or the like (e.g., based on the comparison performed at block 420). The one or more training datasets are fed into the reward model to generate the reward function. The reward model provides the reinforcement learning aspect of RLHF. The reward model can be stored in a storage device 430 (e.g., as reward model (RM) 435). The storage device 430 can be one or more memory components, such as the memory component(s) 120 in FIG. 1.

In some implementations, the outputs 410, the user feedback (the confidence-weighted labels), and/or the points or other awards that the human rater receives based on the user feedback may be stored in the storage device 430 (e.g., as data 440). Other aspects of the user feedback, such as the RT, the speed of the movement of the input device (e.g., a mouse or stylus), any additional commentary or feedback from the human rater (e.g., in text or audio form using the feedback component 240 in FIG. 2), whether the rater indicated a portion of an output option should be ablated (e.g., use of the ablation indicator 230 in FIG. 2), and/or other characteristics of the user feedback can be recorded and stored in the storage device 430 (e.g., as data 440). The other aspects of the user feedback may be used to determine the confidence and/or the veracity of the human rater, and/or to confirm that the rater is a human rater. For example, a lower RT may be interpreted as the human rater having a higher level of confidence in the allocations compared to a higher RT. In some instances, veracity may be defined based on consensus or relative consistency across a group of raters. In one embodiment, the points, the RT, the movement speed of the input device, and/or the other aspects or metrics associated with the user feedback are stored in a user profile associated with the human labeler in the storage device 430. The human labeler may be allowed to view the user profile but not edit the contents of the user profile. Additionally, in some instances, a system administrator or other manager can view, or view and edit, the user profile.

At block 445, the reward model may be used to train (e.g., fine-tune) one or more AI models. The one or more AI models (e.g., retrained or fine-tuned AI models) can be used to generate outputs 410. In some implementations, credits can be dynamically updated, and/or scores and times (e.g., time to review a set of output options) can be updated based on changes in model uncertainty.

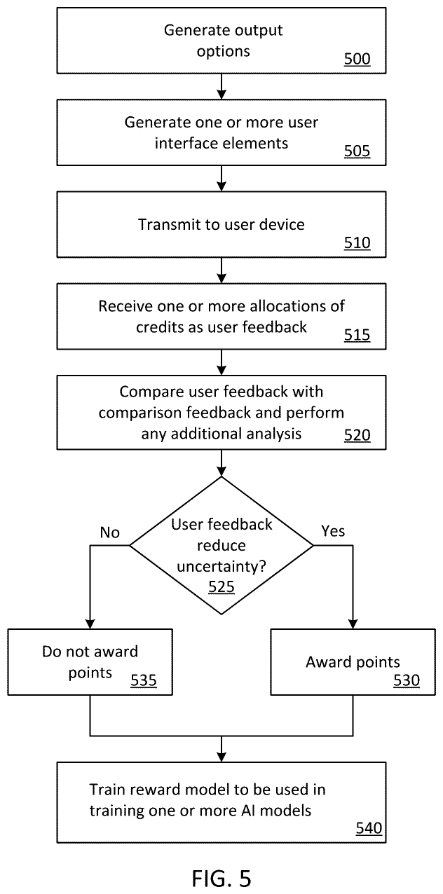

FIG. 5 illustrates a flowchart of an example method of training an artificial intelligence model according to an embodiment of the disclosure. Although the method is described in conjunction with one prompt and a set of corresponding output options, other embodiments can implement the method for multiple prompts and corresponding output options (either concurrently or sequentially). For example, multiple implementations of the method may be performed sequentially or offset in time when two or more human labelers are interested in competing against each other in a game-like environment.

Initially, output options that correspond to a prompt are generated at block 500. An amount of credits may also be generated at block 500. As described earlier, each output option can include, for example, natural language text, images, graphics, and/or videos. Next, as shown in block 505, one or more additional user interface elements may be generated. In some implementations, the one or more additional user interface elements can include some or all of the user interface elements shown in FIG. 2. For example, the one or more additional user interface elements include, but are not limited to, the credit indicator 202, the conversion component 205, the time to completion indicator 210, the points indicator 215, the response timer 235, the feedback component 240, and/or the credits deployed indicator 245.

At block 510, a user interface is transmitted to a user device (e.g., the computer system of FIG. 1). The user interface presents the prompt, the one or more corresponding output options, and the amount of credits, as well as any additional user interface elements at a display (e.g., the display 115 of FIG. 1). An allocation of credits is received for each output option at block 515. The allocation of the credits by the human labeler is referred to as confidence-weighted labeling, and represents user feedback on the output options. The confidence-weighted labels can represent the human-labeled probabilities on the accuracy of the output options. The confidence-weighted labels may be independent of one another. For example, in some implementations, there may be more than one output option that is “correct”, and the allocation of the credits can be independent of each other such that a total of the sum of the allocation of the credits across all of the output options does not need to sum to a particular value.

The allocations of the credits are received via the user interface and each allocation may range from a first amount of credits to a second amount of credits. For example, credits can be allocated in an amount that ranges between zero (0) and one hundred (100) credits for each option, where one hundred credits represents a maximum amount of credits that can be allocated. Additionally or alternatively, a minimum amount of credits that must be allocated on an output option may be set for the output options. The apportionment of the credits enables the human labeler to consider their own uncertainty and also any potential ambiguity in the prompt and corresponding output options. The labeler may allocate a higher numbers of credits to an output option when the human labeler has a higher level of certainty that the output option is the correct or best answer, whereas the human labeler may spread the allocations of credits between several output options, which can indicate that there may be several best or correct output options, or that the human labeler has a lower level of certainty in the output options.

In one embodiment, the human labelers use sliders to allocate the credits (e.g., the sliders 225 in FIG. 2). The sliders can provide a more refined input in that the slider icon may be stopped at any location (e.g., amount) within the range of credits on the slider path. However, other embodiments can use one or more different types of modifiable UI input features for allocation. For example, a numerical input corresponding to a selection can be input into a text field, a selection from a menu of options (e.g., a drop-down menu), and/or a stepper that adjusts (e.g., increases or decreases) an initial allocation by a fixed amount may be used in place of, or in addition to, a slider. In some embodiments, the configuration of the modifiable UI input features may be selected to be engaging and fun with the human labeler. Additionally or alternatively, the UI input features may change over time or with different prompts.

Next, as shown in block 520, the user feedback may be compared with confidence-weighted user feedback comparison data, and any additional analysis can be performed. For example, the user feedback can be compared to feedback provided by a group of users. The additional analysis may include, but not be limited to, an analysis of the confidence and/or the veracity of the human rater. In some implementations, the additional analysis may include statistical analysis of the user feedback (e.g., the responses of the human labeler).

A determination is made at block 525 as to whether the user feedback reduces an uncertainty of at least one AI model. In one implementation, the additional analysis and the results of the comparison performed at block 520 can be considered along with the usefulness, accuracy, and/or desirability of the user's responses to the output options at block 525. If a determination is made that the user feedback reduces the uncertainty of at least one AI model, one or more points are awarded at block 530. In one embodiment, the amount of points that may be awarded is based on the extent to which the user feedback reduces the AI model uncertainty and/or based on the responses of a group of human raters as a whole. In some implementations, a total number of points may be determined based on a number of awarded points minus a number of deducted points.

Returning to block 525, when a determination is made that the user feedback did not reduce the uncertainty of at least one AI model, points are not awarded at block 535. In one implementation, one or more points are deducted. In some implementations, a total number of points may be determined based on a number of awarded points minus a number of deducted points. The method then passes to block 540 where a reward model is generated and trained, and the reward model is used to train one or more AI models. As described earlier, the reward model may include and/or be trained with one or more training datasets that are weighted by the human feedback. Because the reward model is weighted by the human feedback, the reward model can improve the training (e.g., deep reinforcement learning) of the AI model(s). For example, the training may employ less training data and yet be more effective at training the AI model(s). The confidence-weighted labels can produce a better and more accurate reward model to train the AI model(s).

Although FIG. 5 depicts the blocks as being performed in a certain order and sequentially, other embodiments are not limited to this arrangement. Some blocks may be omitted and/or performed in parallel. For example, a single block of “adjusting points” may be substituted for blocks 525, 530, and 535, where the single block of “adjusting points” includes the operation of determining a total number of points to be awarded or deducted. The total number of points may be determined based on a number of awarded points minus a number of deducted points.

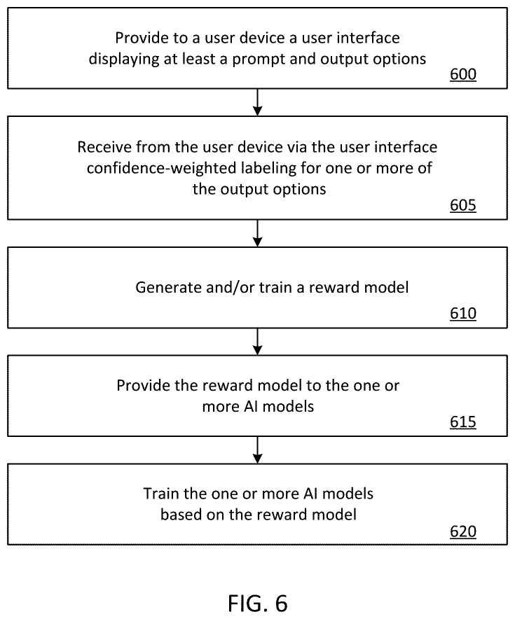

FIG. 6 illustrates a flowchart of a method for training an artificial intelligence model in accordance with an embodiment of the disclosure. The method begins at block 600 where a user interface is provided to a user device (e.g., the computer system 100 of FIG. 1). The user interface displays at least a prompt and output options. In one implementation, the user interface displays a prompt, the output options, and an amount of credits to be apportioned by the human rater. The user interface may include one or more additional user interface elements, such as one or more elements shown in FIG. 2.

Confidence-weighted labels for one or more of the output options are received from the user device at block 605. The confidence-weighted labels can be received from the user device via the user interface. In one embodiment, each confidence-weighted label is received as a respective allocation of credits.

At block 610, a reward model is generated and/or trained for one or more AI models. The reward model can include and/or be trained by one or more training datasets that are weighted by the human feedback (e.g., the confidence-weighted labels). The human feedback may have been received from the user and/or from a group of users. In one embodiment, the one or more AI models are LLMs. The reward model is provided to the one or more AI models at block 615. At block 620, the one or more AI models are trained based on or using the reward model.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method, comprising:
providing, to a user device, a user interface displaying at least a prompt, a plurality of output options to the prompt, and an amount of credits to be apportioned to the plurality of output options;
receiving, from the user device via the user interface, a confidence-weighted label for one or more of the plurality of output options, each confidence weighted label comprising a respective allocation of credits;
based on a determination that the confidence-weighted labels reduce uncertainty of an artificial intelligence (AI) model, generating a reward model for the AI model using the prompt and the confidence-weighted labels; and
training the AI model using the reward model.

2. The method of claim 1, wherein the AI model comprises a large language model.

3. The method of claim 1, wherein the user interface further comprises an allocation indicator configured to indicate an amount of credits allocated to the one or more of the plurality of responses.

4. The method of claim 1, wherein the user interface further comprises at least one of:
a credit indicator configured to indicate the amount of credits to be apportioned to the plurality of responses; or
a credits deployed indicator configured to indicate a total number of credits deployed.

5. The method of claim 1, wherein the user interface further comprises at least one of:
a time to completion indicator configured to indicate an estimated time to completion;
a points indicator configured to indicate a total number of earned points; or
a conversion component configured to convert earned points into available credits.

6. The method of claim 1, wherein the user interface further comprises an ablation indicator, the ablation indicator configured to indicate a portion of at least one output option for ablation.

7. The method of claim 1, further comprising:
awarding one or more points based on the determination that the confidence-weighted labels reduce uncertainty of the AI model; and
storing, in a memory component, the one or more points in a user profile associated with a user that provided the confidence-weighted labels.

8. A method of reinforcement learning from human feedback, the method comprising:
receiving, from an artificial intelligence (AI) model, a plurality of output options;
providing, to a user device, a user interface that displays at least the plurality of output options associated with a prompt and an amount of credits to be apportioned to the plurality of output options;
receiving, from the user device via the user interface, an allocation of credits to each output option in the plurality of output options, each allocation of credits ranging between a first amount of credits and a second amount of credits and the allocations of credits comprising user feedback on the plurality of output options; and
based on the user feedback, performing reinforcement learning from human feedback training using a reward model to train the AI model.

9. The method of claim 8, wherein the first amount of credits is zero and the second amount of credits is a maximum amount of credits that can be allocated to a respective output option.

10. The method of claim 8, wherein the user interface further comprises at least one of:
a credits deployed indicator indicating a total number of credits deployed;
a time to completion indicator indicating an estimated time to completion;
a points indicator indicating a total number of earned points;
a conversion component configured to convert earned points into available credits; or
an ablation indicator, the ablation indicator configured to indicate a portion of at least one output option for ablation.

11. The method of claim 8, further comprising awarding one or more points based on a determination that the user feedback reduces uncertainty of the AI model.

12. The method of claim 11, wherein:
the method further comprises recording at least one of:
a time-to-answer for the allocation of credits; or
a speed of a movement of an input device; and
the time-to-answer or the speed of the movement are considered in the determination that the user feedback reduces uncertainty of the AI model.

13. The method of claim 8, further comprising subtracting one or more points based on a determination that the user feedback does not reduce uncertainty of the AI model.

14. The method of claim 8, wherein the AI model comprises a large language model.

15. The method of claim 8, further comprising receiving, via the user interface, audio input or text input as additional feedback about one or more output options.

16. The method of claim 8, wherein each output option comprises one or more of:
natural language;
an image; or
a video.

17. A system, comprising:
a processor; and
a memory configured to store instructions, that when executed by the processor, cause operations to be performed, the operations comprising:
receiving, from an artificial intelligence (AI) model, a plurality of output options, the plurality of output options based on a prompt;
providing, to a user device, a user interface displaying at least the plurality of output options associated with a prompt and an amount of credits to be apportioned to the plurality of output options;
receiving, from the user device via the user interface, an allocation of credits to each output option in the plurality of output options, each allocation of credits ranging between a first amount of credits and a second amount of credits and the allocations of credits comprising user feedback on the plurality of output options;
based on a determination that the user feedback reduces an uncertainty of the AI model, creating a reward model using the user feedback; and
training the AI model based on the reward model.

18. The system of claim 17, wherein the user interface further comprises at least one of:
a credits deployed indicator indicating a total number of credits deployed;
a time to completion indicator indicating an estimated time to completion;
a points indicator indicating a total number of earned points;
a conversion component configured to convert earned points into available credits; or
an ablation indicator, the ablation indicator configured to indicate a portion of at least one output option for ablation.

19. The system of claim 17, wherein the memory stores further instructions for:
awarding one or more points based on the determination that the user feedback reduces the uncertainty of the AI model; and
subtracting one or more points based on a determination that the user feedback does not reduce the uncertainty of the AI model.

20. The system of claim 19, wherein the memory stores further instructions for comparing the user feedback to confidence-weighted user feedback associated with a group of users prior to awarding the one or more points.
